(19) United States
(12) Patent Application Publication
(10) Pub. No.: US 2012/0311827 A1
(43) Pub. Date: Dec. 13, 2012

(54) Apparatus for an attachment and carrying mechanism for electronic memory, data, or game cards or cartridges

(75) Inventor: Stephen Keith Wilson, Alpharetta, GA (US)

(73) Assignee: Stephen Keith Wilson, Alpharetta, GA (US)

(21) Appl. No.: 13/134,638

(22) Filed: Jun. 13, 2011

(51) Int. Cl. F16B 47/00; F16B 2/20; F16B 45/00; A44B 15/00

(52) U.S. Cl. 24/304

(57) ABSTRACT

An apparatus that attaches to electronic cartridges, cards, disks, or data or memory cards, such as those used in electronic game machines or consoles, digital cameras, and other electronic devices, to provide an attachment point which facilitates attaching or securing the card or cartridge (or multiple cards) to the included split {key} ring or a separate holding or carrying device (such as a clip, cable, strap, or hook), and which provides an improved location for handling the electronic card, particularly when inserting or removing the card from an electronic device. Examples of electronic cards include, but are not limited to: Nintendo DS™ and GameBoy™ game cartridges, and digital memory cards, such as Compact Flash (CF) memory cards. Prior to this invention, carrying or storing these electronic cards was limited to a separate external case from which the card had to be removed prior to use in the intended electronic device.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention is related to the carrying, holding, handling, storing, or securing of electronic memory or data cards, such as those commonly used in electronic game systems or digital cameras. Examples of electronic cartridges or cards include, but are not limited to: Nintendo DS™ 3DS™ and GameBoy™ game cartridges, and digital memory cards, such as Compact Flash (CF) memory cards used in digital cameras and computers. Prior to this invention, carrying or storing these electronic cards was limited to a separate external case (such as a slip-cover case or a snap-in case) from which the card had to be removed prior to use or installation in the intended electronic device (e.g., game console, camera or computer).

### BRIEF SUMMARY OF THE INVENTION

An apparatus to provide an attachment point and carrying mechanism for electronic cartridges, cards, disks, or data or memory cards, such as those used in electronic game machines or consoles, digital cameras, and other electronic devices, which facilitates attaching or securing the card or cartridge to the included split ring or a separate holding or carrying device (such as a clip, cable, strap, or hook), and which provides an improved location for handling the electronic card, particularly when inserting or removing the card from an electronic device. Examples of electronic cartridges or cards include, but are not limited to: Nintendo DS™ and GameBoy™ game cartridges, and digital memory cards, such as Compact Flash (CF) memory cards. Because of the relatively small size of these electronic cards, once removed from the original package or an external storage case, they can be difficult to manipulate, particularly in situations with reduced dexterity, they are now longer attached to the storage or carrying device, and they are also readily subject to loss. This new invention provides an attachment point to the electronic card which does not interfere with the insertion or use of the card in the appropriate electronic device and which facilitates attaching or securing the card to the included split ring or a separate holding or carrying device, such as a clip, cable, strap, or hook. Because of the design of the attachment apparatus, the electronic card does not have to be removed from the apparatus, split ring, or an external carrying device prior to use, thus reducing the risk of loss of the electronic card. In addition, the attachment apparatus provides an improved location to grasp or manipulate the electronic card. When inserted into the appropriate electronic device, the electronic cards often fit flush with the device or have a very limited projection out of the device. The attachment apparatus provides an improved location to hold the card while inserting or removing the card from the device. This is particularly applicable in situations with reduced dexterity, such as wearing gloves while inserting or removing a card from an outdoors camera (e.g., a trail camera or scouting camera).

### BRIEF DESCRIPTION OF THE SEVERAL VIEWS OF THE DRAWING

FIG. 1: An exploded view illustrating the components of the claimed apparatus (Items 3 through 8), unassembled, with an example of an electronic game console (Item 1) and an example of an electronic game cartridge (Item 2). Items 1 and 2 are not claimed. The claimed apparatus consists of a bent or curved bar (Item 3), sleeves (Item 4), a swivel (Item 5), adhesive tape or film (Item 6), a split ring (Item 7), and a larger split ring (Item 8).

FIG. 2: Illustrates the claimed apparatus (Item 9), assembled, but not attached to the electronic game cartridge (Item 2). Item 9 attaches to the top end of the electronic cartridge (Item 2) shown in closest proximity to Item 9.

FIG. 3: Illustrates the assembled apparatus (Item 9) attached to the electronic game cartridge (Item 2), which is shown inserted into the electronic game console (Item 1). As illustrated, the assembled apparatus (Item 9) does not interfere with the insertion or use of the cartridge (Item 2) in the electronic game console (Item 1).

### DETAILED DESCRIPTION OF THE INVENTION

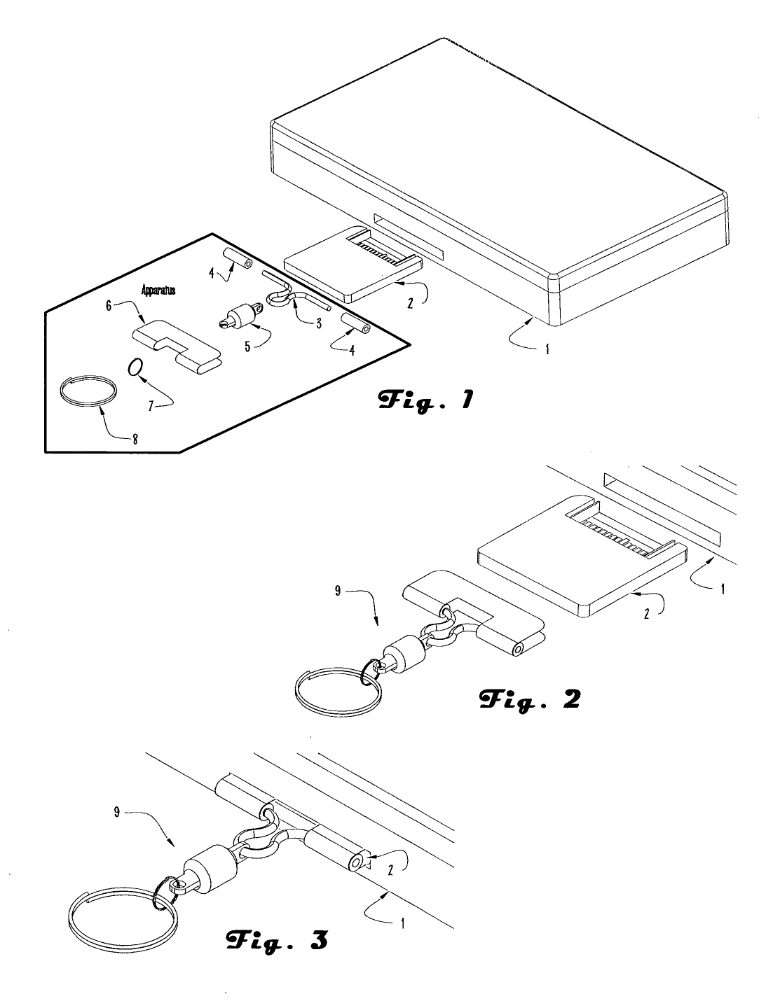

The attachment apparatus consists of the components illustrated in FIG. 1: a bent or curved bar (Item 3), two sleeves (Item 4), one over each end of the bar, a swivel (Item 5), an adhesive tape or film with a removable non-stick backing (Item 6), and a ring (Item 7), such as a split or key ring, and an additional, larger ring (Item 8). The attachment is constructed by first sliding the bar (Item 3) through the integral lower loop in the swivel (Item 5), and then sliding one sleeve (Item 4) over each end of the bar (Item 3). A strip of non-stick backing is removed from the adhesive tape or film (Item 6), and the tape or film attached to the sleeves (Item 4), with the curve of the bar (Item 3) and the swivel (Item 5) projecting through a slot in the tape or film (Item 6). The remainder of the non-stick backing is left on the adhesive tape or film (Item 6) for the end user to remove and subsequently apply the adhesive tape or film (Item 6) to the electronic card or cartridge (Item 2). A small split ring (Item 7) is then attached to the swivel (Item 5) by opening the ring, sliding it onto the upper integral loop of the swivel, and then closing the ring. A larger split ring (Item 8) is attached to the small split ring (Item 7) by opening the ring, sliding it onto the smaller ring, and then closing the ring.

The bar (Item 3) has a bend or curve in it, allowing the bar to be inserted in the sleeves (Item 4) without adhesive, thus allowing it to rotate freely inside the sleeves in a direction perpendicular to the face of the attached cartridge, which may reduce torque and other directional stresses or strains which may be applied to the attachment point or the attached electronic cartridge or card. The bend in the bar also facilitates the multi-directional movement of the attached swivel (Item 5), which also may reduce torque and other directional stresses or strains which may be applied to the attachment point or the attached cartridge or card. The sleeves (Item 4) are held in place on the bar by the adhesive tape or film (Item 6), the latter of which also attaches the fully assembled apparatus (Item 9) to the electronic card or cartridge. The adhesive tape or film (Item 6) is a thin layer that it does not interfere with the insertion into, or use of the attached electronic cartridge or card in, the electronic device for which it is intended (e.g., it does not interfere with insertion and use of a game cartridge into game console or CF card into a camera.) Attached to the bar (Item 3) is a swivel (Item 5) that functions to reduce torque on the attachment point and the attached cartridge or card. Attached to the swivel (Item 5) is a ring (Item 7), which provides the attachment location for an external holding or carrying device, such as a clip, cable, strap, hook, or split (key) ring. The additional, larger ring (Item 8) will hold multiple claimed apparatuses or can be used for attachment to an external carrying or holding device use with larger external holding devices, such as hooks or clips.

I claim:

1. An attachment and carrying apparatus for electronic memory, data, or game cards or cartridges, comprising: (a) two sleeves: (i) one located one each end of a curved or bent bar, and (ii) for positioning by the end user on the exposed or visible surface of an electronic card or cartridge when said card or cartridge is installed into an appropriate electronic device, and (iii) held in position by a thin adhesive film or tape, which also attaches the apparatus to the electronic card or cartridge; (b) a bent or curved bar: (i) held by the aforementioned sleeves, (ii) which may slide parallel to the axis of the sleeves, (iii) which may rotate perpendicular to the axis of the sleeves, (iv) which is placed through the integral lower loop of the swivel, (v) which holds the swivel, and (vi) which allows the swivel to move along the curve of the bar, as well as parallel and perpendicular to the axis of the bar; (c) a swivel: (i) including integral lower and upper loops, (ii) the lower loop holds the bar and moves freely along the bar, allowing the swivel to point in any direction, impeded only by the physical obstruction of the sleeves or attached electronic card, (iii) the swivel rotates three hundred sixty degrees in either clockwise or counterclockwise directions, (iv) the upper integral loop of the swivel is attached to a split ring; (d) a thin adhesive tape or film: (i) holds the sleeves in position on the axis of the bar, (ii) is backed with removable backing for removal by the end user for (iii) attachment of the apparatus to the electronic card or cartridge, and (iv) does not interfere with the use or insertion of the electronic card or cartridge into the intended electronic device; (e) a small split ring: (i) attached to the upper integral loop of the swivel, (ii) providing an attachment point for the larger split ring, or an external holding or carrying device, such as a clip, cable, strap, or hook; (f) a larger split ring: (i) will hold multiple claimed apparatuses, or (ii) can be used for attachment to an external carrying or holding device use with larger external holding devices, such as hooks or clips.

2. The apparatus in claim 1, with a clip, cable, strap, or hook attached to the split rings or swivel.

3. The apparatus in claim 1, wherein multiple pieces of adhesive film are utilized.

4. The apparatus in claim 1, wherein a flexible material, such as cordage, is used for the curved bar.

5. The apparatus in claim 1, with one or no sleeves.
